(19) United States
(12) Patent Application Publication
(10) Pub. No.: US 2011/0019435 A1
(43) Pub. Date: Jan. 27, 2011

(54) Brightness enhancement film and backlight module

(75) Inventors: Tun-Chien Teng, Hsinchu (TW); Chih-Jen Tsang, Hsinchu (TW); Ming-Feng Kuo, Hsinchu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsinchu (TW)

(21) Appl. No.: 12/801,612

(22) Filed: Jun. 17, 2010

(30) Foreign Application Priority Data
Jul. 22, 2009 (TW) 098124805

(51) Int. Cl. F21V 5/02; G02B 27/12

(52) U.S. Cl. 362/608; 359/622

(57) ABSTRACT

A brightness enhancement film (BEF) includes a substrate, a prism layer, a connection structure layer, and a micro lens layer. The prism layer is disposed on the substrate, the micro lens layer is disposed above the prism layer, and the connection structure layer is disposed between the prism layer and the micro lens layer. The prism layer includes a plurality of prisms. Each of the prisms includes a plurality of prism units. The micro lens layer includes a plurality of micro lens units. The connection structure layer includes a plurality of connection structure units. Each of the connection structure units connects the prism unit and the micro lens unit. A side surface of each of the connection structure units is a curved surface, and the curved surface extends from the micro lens unit to the prism unit. A backlight module including the brightness enhancement film is also provided.

### CROSS-REFERENCE TO RELATED APPLICATION

This application claims the priority benefit of Taiwan application serial no. 98124805, filed on Jul. 22, 2009. The entirety of the above-mentioned patent application is hereby incorporated by reference herein and made a part of this specification.

### BACKGROUND OF THE INVENTION

1. Field of the Invention

The invention relates to an optical film and a light source module, and more particularly, to a brightness enhancement film (BEF) and a backlight module.

2. Description of Related Art

Referring to FIGS. 1A and 1B, a conventional backlight module 100 includes a reflection sheet 110, a plurality of cold cathode fluorescent lamps (CCFLs) 120, a bottom diffuser 130, a prism sheet 140, and a top diffuser 150 sequentially disposed from the rear side to the front side. The CCFLs 120 are capable of emitting a light beam 122. A part of the light beam 122 strikes the reflection sheet 110, and then is reflected by the reflection sheet 110 onto the bottom diffuser 130 and transmitted to the prism sheet 140. Another part of the light beam 122 directly strikes onto the bottom diffuser 130 and is transmitted onto the prism sheet 140.

The prism sheet 140 includes a plurality of prisms 142 arranged parallelly. Each of the prisms 142 extends along a first direction D1, and the prisms 142 are arranged along a second direction D2. The prisms 142 select the incident angles of the incident light beams 122. It is to say that an incident light beam 122 with an incident angle within a particular angle range is able to pass through the prisms 142, so that the light beam 122 emitted out of the prism sheet 140 is as perpendicular as possible to the top diffuser 150. Therefore a light collecting effect of the prism sheet 140 is achieved, and the backlight module 100 is capable of providing a surface light source with more concentrative light emitting angles. For example, the light ray 122a of the light beam 122 may pass through the prisms 142 and reach the top diffuser 150. However, the light rays 122b and 122c of the light beam 122 may be reflected by the prisms 142 back onto the reflection sheet 110. Then, the reflection sheet 110 reflects the light rays 122b and 122c onto the prism sheet 140 so as to reuse the light rays 122b and 122c. The prisms 142 allow a part of the above-mentioned reused light beam 122 to pass through and reflect another part of the reused light beam 122 once more. Therefore a part of the light beam 122 circulates between the prisms 142 and the reflection sheet 110 many times until passing through the prisms 142, so that the backlight module 100 may improve the light emitting ratio of the light beam with a direction approximately perpendicular to the light emitting surface and further improve the usage efficiency of the light beam after the light beam emits from the light guide plate 100.

In addition, since the profile of the prism sheet 140 (i.e., the top crest lines 144 and the boundary lines 143 between any two adjacent prisms 142) apparently makes that the pixel array of the liquid crystal panel (not shown) disposed over the backlight module 100 generates moire fringes or Newton's rings, and further results in uneven display image provided by the liquid crystal panel. Besides, since the top diffuser 150 is disposed on the top of the prism sheet 140, the cost of the backlight module 100 may be hard to decrease.

Furthermore, when the top diffuser 150 is added to improve the above-mentioned problem, the crest lines 144 of the top of the prisms 142 may also result in scratch of the adjacent film (for example the top diffuser 150) and the prism 140, and the reliability and the durability of the backlight module 100 may be decreased.

American patent publication No. US20070279940 discloses another conventional brightness enhancement film (BEF). Please refer to FIG. 2, the BEF 240 includes prisms 241 and a plurality of microstructures 242, wherein the microstructures 242 includes microstructures 2421, 2422, 2423 with different sizes, and the microstructures 242 are disposed disorderly on the prisms 241, which decreases the gain of the prisms greatly.

Please refer to FIG. 3, U.S. Pat. No. 734,428 discloses another conventional BEF 340 including a plurality of protruding structures 341.

### SUMMARY OF THE INVENTION

The invention provides a brightness enhancement film (BEF), having good light condensing and light shielding characters.

The invention provides a backlight module, capable of providing a surface light source having smaller light emitting angle and more uniform brightness.

Other objectives and advantages of the invention may be further understood by the disclosures of the invention.

To achieve at least one of or other objectives, an embodiment of the invention provides a brightness enhancement film, including a prism layer, a connection structure layer, and a micro lens layer. The prism layer includes a plurality of prisms, and each of the prisms includes a plurality of prism units. The micro lens layer includes a plurality of micro lens units, and each of the micro lens units is disposed on the prism unit. The connection structure layer includes a plurality of connection structure units, and each of the connection structure units connects the prism unit and the micro lens unit, wherein a side surface of the connection structure unit is a curved surface, and the curved surface extends from the micro lens unit to the prism unit.

In one embodiment of the invention, the BEF further includes a substrate, and the prism layer is disposed on the substrate. Each of the prisms of the prism layer extends along a first direction, and is arranged along a second direction adjacent to each other. The first direction is substantially perpendicular to the second direction. A cross section of the prism unit of the prism is a trapezoid.

In one embodiment of the invention, the micro lens units of the micro lens layer may be rounded protrusions, elliptical protrusions, spherically-shaped protrusions, hemispherically-shaped protrusions, or the combination of the above mentioned protrusions.

In one embodiment of the invention, a curvature of the side surface of the connection structure unit is gradually increased along a direction away from the prism unit.

In one embodiment of the invention, the ratio of an orthogonal projection area of the micro lens unit on the substrate to an orthogonal projection area of the corresponding prism unit on the substrate falls in a range between 25% and 60%.

Another embodiment of the invention provides a backlight module, including a first BEF and at least a light emitting device. The first BEF is the BEF of one of the above mentioned embodiments of the invention, the light emitting device is capable of emitting a light beam, and the first BEF is disposed in the transmissive path of the light beam.

In another embodiment of the invention, the backlight module further comprises a second BEF. The second BEF is substantially the same as the first BEF, and the second BEF and the first BEF are disposed one above another and are substantially perpendicular to each other.

In summary, the embodiment or embodiments of the invention may have at least one of the following advantages. In the BEF of the embodiment of the invention, the prism unit may reduce the light emitting angle to providing good light condensing effect. The micro lens unit may gather and uniform the light emitting beam, and may provide light diffusion effect. The smooth curved surface of the connection structure unit may uniform the light emitting beam to further improve light diffusion effect. The light emitting angle may be adjusted through adjusting the ratio of the orthogonal projection area of the prism unit on the substrate to the orthogonal projection area of the micro lens unit on the substrate.

Comparing with the conventional mechanism of the prism (i.e., injecting light beam repeatedly and circularly), the BEF of the embodiment of the invention may improve the consumption of the light efficiency for the conventional prism resulting from the absorption of the material, and the light diffusion effect produced by the micro lens unit and the connection structure unit may generate a good light shielding character. The BEF of the embodiment of the invention also has good light condensing and light shielding characters, and the micro lens unit and the smooth top surface may also decrease the scratch of the adjacent optical film. In this way, the backlight module using the BEF of the embodiment of the invention not only decreases the reject ratio of the product, but also providing a surface light source having smaller light emitting angle and more uniform brightness.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a cross-sectional diagram of a conventional backlight module.

FIG. 1B is a three dimensional diagram of the prism sheet in FIG. 1A.

FIG. 2 is a three dimensional diagram of a conventional BEF.

FIG. 3 is a three dimensional diagram of a conventional BEF.

FIG. 4 is a cross-sectional diagram of the backlight module according to the first embodiment of the invention.

FIG. 5 is a top view of the BEF according to the first embodiment of the invention.

FIG. 6 is a three view drawing of the micro structure unit of the BEF according to the first embodiment of the invention.

FIG. 7 is a distribution diagram of the illumination intensity ratio corresponding to the light emitting angle of the emitting light beam of the BEF, Lambertian light source, and the conventional prism sheet according to an embodiment of the invention.

FIG. 8 is a cross-sectional diagram of a backlight module according to the second embodiment of the invention.

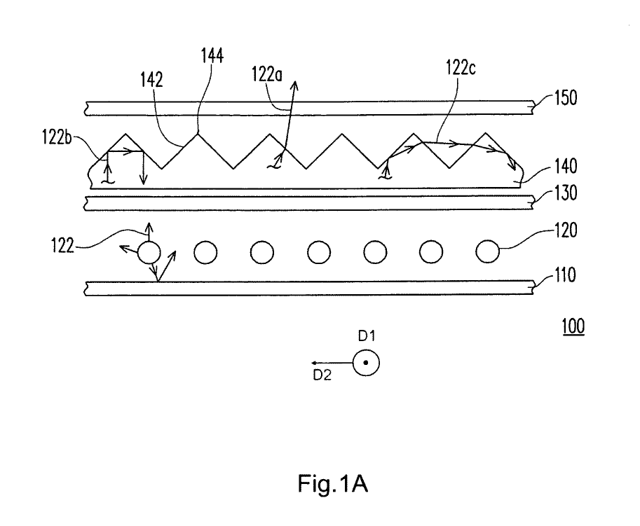

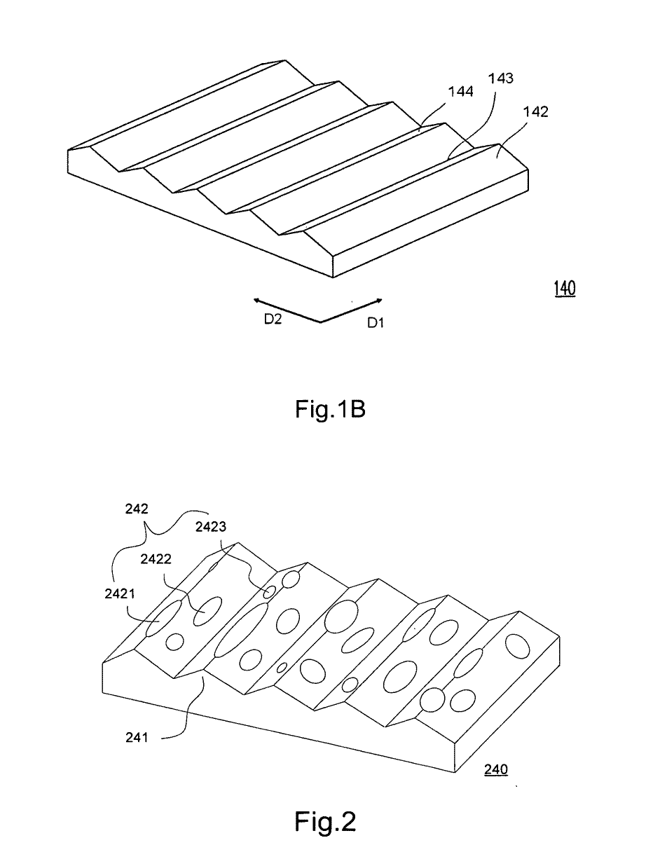

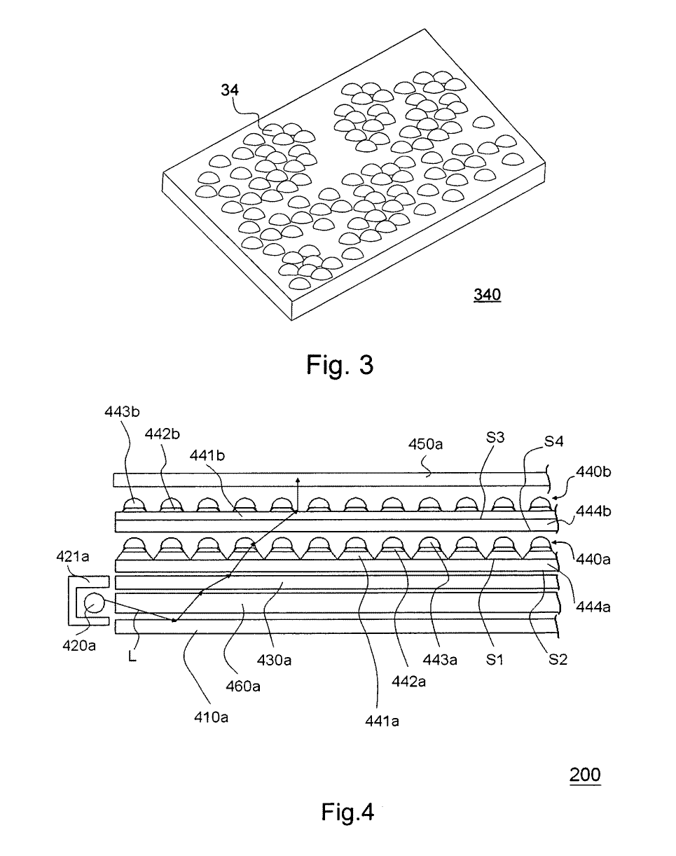

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

A backlight module 200 of the embodiment is a side type backlight module and includes a first BEF 440a, at least a light emitting device 420a, and a lamp cover 421a. The first BEF 440a includes a prism layer 441a, a micro lens layer 443a, a connection structure layer 442a, and a substrate 444a. The prism layer 441a is disposed on the substrate 444a, the micro lens layer 443a is disposed on the top of the prism layer 441a, and the connection structure layer 442a is disposed on the prism layer 441a and is disposed between the micro lens layer 443a and the prism layer 441a to connect the micro lens layer 442a and the prism layer 441a. The light emitting device 420a is capable of emitting a light beam L, the lamp cover 421a surrounds the light emitting device 420a to reflect a part of the light beam L emitted from the light emitting device 420a, and the first BEF 440a is disposed in the transmission path of the light beam L. In the embodiment, the substrate 444a, the prism layer 441a, the connection structure layer 442a, and the micro lens layer 443a of the first BEF 440a are all disposed in the transmission path of the light beam L. In the embodiment, the light emitting device 420a is a light emitting diode, for example. However, in other embodiment, the cold cathode fluorescent lamp may take the place of the light emitting diode.

In the first BEF 440a of the embodiment, the substrate 444a may be a transparent substrate, a transparent film or other transparent devices. The substrate 444a has a light incident surface S2 and a light emitting surface S1 opposite to the light incident surface S2. The prism layer 441a is formed on the light emitting surface S1 of the substrate 444a. In addition, the light incident surface S2 of the substrate 444a is a smooth optical surface or a rough optical surface to transmit the light beam L (not shown).

In the embodiment, the backlight module 200 not only includes a first BEF 440a and at least a light emitting device 420a, but also includes a light guide plate 460a and a reflection sheet 410a. The light emitting devices 420a is disposed on the side surface of the light guide plate 460a and is capable of emitting a light beam L, and the light guide plate 460a is disposed in the transmission path of the light beam L between the light emitting device 420a and the first BEF 440a. In the embodiment, a part of the light beam L emits into the light guide plate 460a directly, and then is transmitted to the first BEF 440a. A part of the light beam L emits to the reflection sheet 410a, then is reflected to the light guide plate 460a by the reflection sheet 410a, and is transmitted to the first BEF 440a. After emitting into the light guide plate 460a, a part of the light beam L is transmitted to the reflection sheet 410a through the optical micro structure (not shown) on the light guide plate 460a, and is reflected back to the light guide plate 460a by the reflection sheet 410a, and then is transmitted to the first BEF 440a; or a part of the light beam L is transmitted into the first BEF 440a through the optical micro structure on the light guide plate 460a.

In the embodiment, the backlight module 200 further includes a bottom diffuser 430a and a top diffuser 450a. The bottom diffuser 430a is disposed between the light guide plate 460a and the first BEF 440a to diffuse and uniform the light beam L emitted from the light guide plate 460a. The top diffusion 450a is disposed on the first BEF 440a to diffuse and uniform the light beam L emitted from the first BEF 440a. In another embodiment, the backlight module 200 may not use the top diffuser 450a, and even not use the bottom diffuser 430a, so as to reduce the thickness, manufacture cost, and light loss of the backlight module 200 according to the embodiment of the invention.

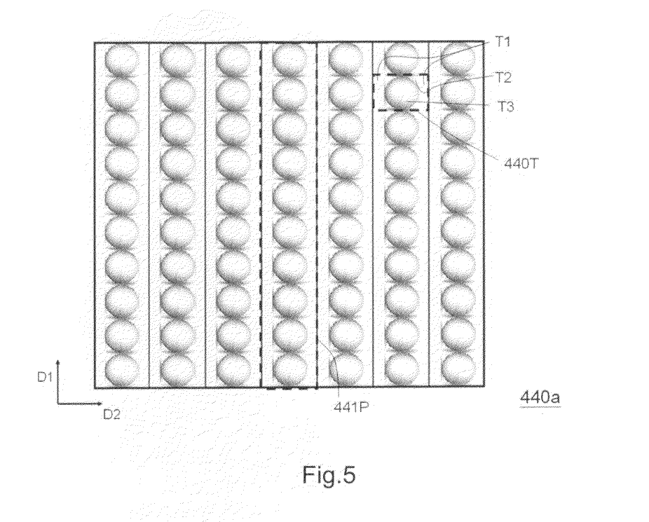

Please refer to FIGS. 4 and 5, the prism layer 441a includes a plurality of prisms 441P, the prisms 441P extend along a first direction D1 and are arranged closely along a second direction D2, and the first direction D1 is substantially perpendicular to the second direction D2. Each of the prisms 441P is substantially a trapezoid structure, and the cross section of each of the prism 441P along the second direction D2 may be a trapezoid or an isosceles trapezoid, wherein the length of the bottom of the trapezoid or the isosceles trapezoid is more than the length of the top of the trapezoid or the isosceles trapezoid, the bottom is connected to the substrate 444a, and the top is connected to the connection structure layer 442a. In addition, two adjacent prisms 441P of the prism layer 441a are connected to each other and form a V typed trench. The structure of the V typed trench allows the incident light beam with an incident angle falling in a certain range to pass through, so that the light beam emitted from the first BEF 440a may be as perpendicular to the light emitting surface S1 of the substrate 444a as possible. In this way, the first BEF 440a of the embodiment may achieve the light condensing effect.

Moreover, each of the prisms 441P includes a plurality of prism units T1, each of the prism units T1 of the same prism 441P is connected to each other along the first direction D1, and each prism unit T1 and the corresponding micro lens unit T3 are connected to each other through the connection structure unit T2. A corresponding prism unit T1, a corresponding connection structure unit T2, and a corresponding micro lens unit T3 constitute a micro structure unit 440T of the first BEF 440a according to the first embodiment of the invention.

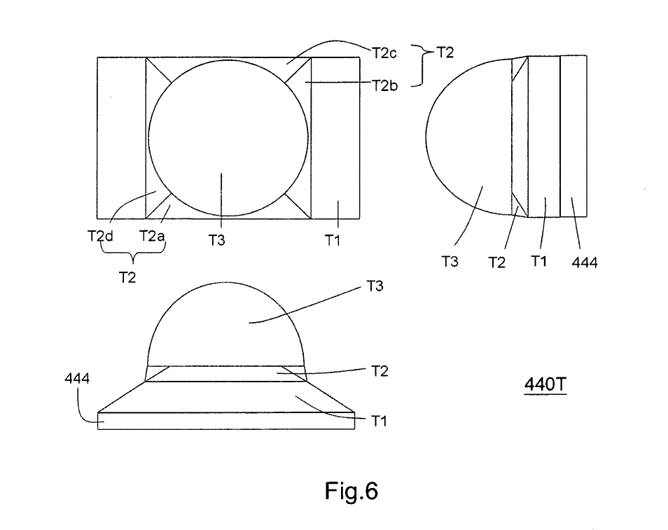

Please refer to FIGS. 5 and 6 at the same time, the cross section of the prism unit T1 along the first direction D1 is substantially a rectangle, the cross section of the prism unit T1 along the second direction D2 is substantially a trapezoid or an isosceles trapezoid, wherein the bottom of the trapezoid or the isosceles trapezoid is greater than the top of the trapezoid or the isosceles trapezoid, the bottom is connected to the substrate, and the top is connected to the connection structure unit T2. The micro lens unit T3 has a curved surface protruding toward the direction away from the prism unit T1. The curved surface of the micro lens unit T3 protruding toward the direction away from the prism unit T1 may be rounded protrusions, elliptical protrusions, spherically-shaped protrusions, hemispherically-shaped protrusions, or the combination of the above mentioned protrusions. The connection structure unit T2 includes four side surfaces, and the four side surfaces are respectively T2a, T2b, T2c, and T2d. The curvature of each of the side surfaces increases gradually along the direction away from the prism unit T1, the horizontal width of each of the side surfaces decreases gradually along the direction away from prism unit T1, each side surface is a smooth surface extending from the fringe of the prism unit T3 to the prism unit T1, and the connection part of each of the side surfaces of the connection structure units T2 has a smooth ridge line.

A V typed trench structure is formed between the two adjacent prism units T1 of the two adjacent prisms 441P. The V typed trenches extend along the first direction D1 and are arranged along the second direction D2. Therefore, the light emitting angle of the first BEF 440a in the first direction D1 is different from the light emitting angle of the first BEF 440a in the second direction D2, and the light emitting angle in the first direction D1 is greater than the light emitting angle in the second direction D2. Because the V typed trench structure allows the incident light falling in a certain angle range to pass through, the V typed trench structure may make the first BEF 440a have the light condensing effect similar to the conventional prism and make the light beam emitted from the first BEF 440a be as perpendicular to light emitting surface S1 of the substrate 444 as possible, so that the first BEF 440a has the light condensing effect.

From above, the curved surface of the micro lens unit T3 protruding toward the direction away from the prism unit T1 may be rounded protrusions, elliptical protrusions, spherically-shaped protrusions, hemispherically-shaped protrusions, or the combination of the above mentioned protrusions. Since the normal direction of the point on the curved surface varies with the curved surface, the emitting light may be refracted with different angles and has different scattering angles resulting from the incident lights passing through the micro lens unit T3 in different positions. In this way, the micro lens unit T3 may has at least one of the uniformity effect of the emitting light, the blur effect, and the shielding effect. In addition, the curved surface of the micro lens unit T3 may form a smooth top, so the scratch of the optical film stacked adjacently on the micro lens unit T3 may be decreased and the first BEF 440a of the embodiment may avoid that the conventional prism sheet scratches the optical film stacked adjacently on the conventional prism sheet.

Furthermore, each of the smooth curved surfaces of the side surface T2a, T2b, T2c, and T2d of the connection structure unit T2 extends from the curved surface of the micro lens unit T3 protruding toward the direction away from the prism unit T1 to the prism unit T1. The cross section of the connection part between the connection structure unit T2 and the micro lens unit T3 parallel to the light emitting surface S1 of the substrate 444 is a circle or an ellipse. The cross section of the connection part between the connection structure unit T2 and the prism unit T1 parallel to the light emitting surface of the substrate 444 is a rectangle. Therefore, the side surfaces T2a, T2b, T2c, and T2d of the connection structure unit T2 on a side of the micro lens unit T3 may form a circle or an ellipse, and the side surfaces T2a, T2b, T2c, and T2d of the connection structure unit T2 on a side of the prism unit T1 may form a rectangle. In addition, the curved surface of the micro lens unit T3 protruding toward the direction away from the prism unit T1 may be rounded protrusions, elliptical protrusions, spherically-shaped protrusions, hemispherically-shaped protrusions, or the combination of the above mentioned protrusions, the side surfaces T2a, T2b, T2c, and T2d of the connection structure unit T2 may be adjusted according the different shapes of the micro lens unit T3, and an orthogonal projection shape of the side of the prism unit T1 connecting with the connection structure unit T2 on the substrate is a rectangle, so the connection part of any two adjacent side surfaces of the four side surfaces T2a, T2b, T2c, and T2d of the connection structure unit T2 forms a ridge line. The four side surfaces T2a, T2b, T2c, and T2d of the connection structure unit T2 are smooth curved surfaces, and the normal direction of the point on the curved surfaces varies with the curved surface, so the emitting light may be refracted with different angles and has different scattering angles resulting from the incident light passing through the connection structure unit T2 in different positions. In this way, the connection structure unit T2 may has at least one of the uniformity effect of the emitting light, the blur effect, and the shielding effect.

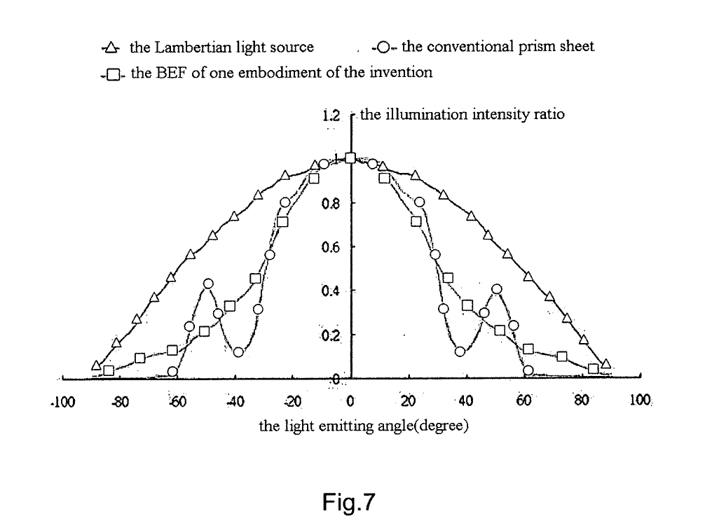

The followings may describe the effect of the first BEF 440a of the embodiment of the invention according to the optical simulation diagram. Please refer to FIG. 7, the vertical axis represents the ratio of the illumination intensity, the lateral axis represents the light emitting angle, and assume that the ratio of the illumination intensity emitted from the light source is 1. When the light emitting angle is close to 0 degree, the ratio of the illumination intensity emitted from the first BEF 440a of the embodiment is close to the ratio of the illumination intensity emitted from the conventional prism. In other word, the forward gain of the first BEF 440a of the embodiment for the light source (such as a Lambertian light source) is close to the forward gain of the conventional prism for the light source. In addition, when the light emitting angle is close to 40 degrees, the ratio of the illumination intensity emitted from the first BEF 440a is much greater than the ratio of the illumination intensity emitted from the conventional prism, and the light beam with such the light emitting angle may also be used. So the light emitting efficiency of the backlight module 200 using the first BEF 440a of the embodiment is better than the light emitting efficiency of the backlight module using the conventional prism. Furthermore, when the light emitting angle is close to 70 degrees, the ratio of the illumination intensity emitted from the conventional prism may be more than the ratio of the illumination intensity emitted from the first BEF 440a. However, the light beam with the light emitting angle may not be effectively used, and the lost may be caused. Therefore, the loss of the backlight module 200 using the first BEF 440a of the embodiment is less than the loss of the backlight module using the conventional prism. From above, the BEF 440a of the embodiment has better light condensing effect.

The optical simulation diagram shown in FIG. 7 is not intended to limit the invention, and other optical simulation diagrams may be obtained by the BEF of other embodiments or with other parametric conditions.

In addition, the backlight module 200 of the embodiment not only includes the first BEF 440a, the light emitting device 420a, the light guide plate 460a, and the reflection sheet 410a, but also includes a second BEF 440b. The second BEF 440b includes a prism layer 441b, a micro lens layer 443b, a connection structure layer 442b, and a substrate 444b, and the substrate 444b has a light incident surface S4 and a light emitting surface S3 opposite to the light incident surface. In the embodiment, the second BEF 440b is substantially the same with the first BEF 440a, the second BEF 440b is disposed above the first BEF 440a, and the first BEF 440a and the second BEF 440b are substantially perpendicular to each other. To be specific, the extending direction of the prism 441P on the first BEF 440a is substantially perpendicular to the extending direction of the prism 441P on the second BEF 440b, and the adjacently arrayed direction of the prism 441P on the first BEF 440a is substantially perpendicular to the adjacently arrayed direction of the prism 441P on the second BEF 440b. Since the light emitting angle of the extending direction and the arrayed direction of the prism 441P on the BEFs 440a and 440b of the embodiment of the invention is different from each other, the light emitting angle may be decreased when the first BEF 440a and the second BEF 440 of the backlight module 200 of the embodiment are disposed one above another and are substantially perpendicular to each other.

Table 1 is an optical simulation effect table of the embodiment. Please refer to Table 1, the comparison between the backlight module 200 of the embodiment using the first BEF 440a and the second BEF 440b perpendicular to each other and the backlight module 200 of another embodiment using the first BEF 440a merely is shown as follows. The illumination gain value in the normal direction of the light emitting surface of the backlight module 200 of the another embodiment using the first BEF 440a merely is smaller (such as 1.68), the horizontal light emitting angle is greater (such as 38 degrees), and the perpendicular light emitting angle is greater (such as 38 degrees), while the illumination gain value in the normal direction of the light emitting surface of the backlight module 200 of the embodiment using the first BEF 440a and the second BEF 440b perpendicular to each other is greater (such as 2.13), the horizontal light emitting angle is smaller (such as 30 degrees), and the perpendicular light emitting angle is smaller (such as 32 degrees).

TABLE 1

| | |
|---|---|
| | using the first BEF 440a merely |
| illumination gain in the | 1.68 |
| normal direction of the light | |
| emitting surface | |
| horizontal light emitting | 38° |
| angle | |
| perpendicular light emitting | 44° |
| angle | |
| | using the first BEF 440a and the second BEF |
| | 440b disposed one above another and perpendicular to each |
| | other |
| illumination gain in the | 2.13 |
| normal direction of the light | |
| emitting surface | |
| horizontal light emitting | 30° |
| angle | |
| perpendicular light emitting | 32° |
| angle | |

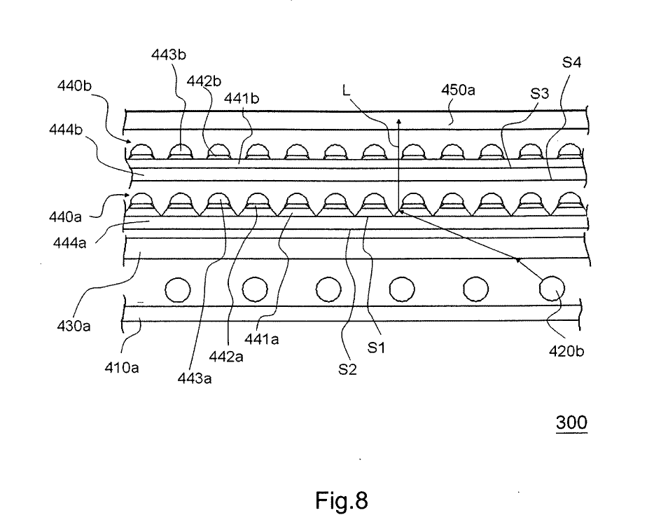

The differences between the backlight module 300 of the embodiment in FIG. 8 and the backlight module 200 described above (as show in FIG. 4) are described as follows. The backlight module 300 of the embodiment is a direct backlight module different from the side type backlight module 200 in FIG. 4. The light emitting device 420a of the backlight module 200 in FIG. 4 is disposed at the edge side of the light guide plate 460a, and the light guide plate 460a is disposed in the transmission path of the light beam L between the light emitting device 420a and the first BEF 440a, while the backlight module 300 of the embodiment has no light guide plate, and a plurality of light emitting devices 420b are disposed under the first BEF 440a. To be specific, the light emitting devices 420b are disposed between the first BEF 420b and the reflection sheet 410a. In the embodiment, the light emitting devices 420b are, for example, cold cathode fluorescent lamps. However, in other embodiment, the light emitting devices may be light emitting diodes.

In summary, the embodiment or embodiments of the invention may have at least one of the following advantages:

In the BEF of the embodiment of the invention, the prism unit may provide good light condensing effect, and the connection structure unit and the micro lens unit may provide good light diffusion effect, wherein the good light diffusion effect may provide good shielding effect. By adjusting the area ratio of the prism unit, the micro lens unit, and the connection structure unit, the ratio of the light condensing effect to the light diffusion effect of the BEF according to the embodiment of the invention may be adjusted, so the light condensing effect and the light diffusion effect of the BEF of the embodiment of the invention may be adjusted according to the different optical design of the backlight module, and a good design of the BEF may be provided. In addition, the perpendicular design of the two BEFs of the embodiment of the invention may further improve the illumination gain of the emitting light beam in the normal direction of the light emitting surface and reduce the light emitting angle, so that the backlight module using the BEF of the embodiment of the invention may provide surface light source with little light emitting angle and uniform and high illumination.

In addition, since the curved surface of the micro lens unit and the connection structure unit of the BEF of the embodiment has light diffusion character, the BEF has good shielding effect. In this way, the top diffuser may be saved, and even the bottom diffuser may be saved so as to effectively reduce the thickness, the manufacture cost, and the light loss of the backlight module of the embodiment of the invention.

The top of the curved surface of the micro lens unit of the BEF of the embodiment has no the ridge line structure, easy to scratch between the conventional prism sheet and the adjacent film. Accordingly, the BEF of the embodiment has the effect preventing scratching the adjacent film, so as to effectively improve the reliability and the durability of the backlight module of the embodiment of the invention.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A brightness enhancement film, comprising:
a prism layer, comprising a plurality of prisms, wherein each of the prisms comprises a plurality of prism units;
a micro lens layer, comprising a plurality of micro lens units, wherein each of the micro lens units is disposed on the prism unit; and
a connection structure layer, comprising a plurality of connection structure units, wherein each of the connection structure units connects the prism unit and the micro lens unit, a side surface of the connection structure unit is a curved surface, and the curved surface extends from the micro lens unit to the prism unit.

2. The brightness enhancement film according to claim 1, wherein the prisms of the prism layer extend along a first direction and are arranged along a second direction.

3. The brightness enhancement film according to claim 2, wherein the first direction is substantially perpendicular to the second direction.

4. The brightness enhancement film according to claim 1, wherein the prisms are adjacent to each other.

5. The brightness enhancement film according to claim 1, further comprising a substrate, wherein the prism layer is disposed on the substrate.

6. The brightness enhancement film according to claim 5, wherein the ratio of an orthogonal projection area of the micro lens unit on the substrate to an orthogonal projection area of the corresponding prism unit on the substrate falls in a range between 25% and 60%.

7. The brightness enhancement film according to claim 1, wherein a cross section of the prism unit is a trapezoid.

8. The brightness enhancement film according to claim 1, wherein the micro lens units are rounded protrusions, elliptical protrusions, spherically-shaped protrusions, hemispherically-shaped protrusions, or the combination of the above mentioned protrusions.

9. The brightness enhancement film according to claim 1, wherein a curvature of the side surface of the connection structure unit is gradually increased along a direction away from the prism unit.

10. A backlight module, comprising:
a first brightness enhancement film, comprising:
a prism layer, comprising a plurality of prisms, wherein each of the prisms comprises a plurality of prism units;
a micro lens layer, comprising a plurality of micro lens units, wherein each of the micro lens units is disposed on the prism unit; and
a connection structure layer, comprising a plurality of connection structure units, wherein each of the connection structure units connects the prism unit and the micro lens unit, a side surface of the connection structure unit is a curved surface, and the curved surface extends from the micro lens unit to the prism unit; and
at least one light emitting element, capable of emitting a light beam, wherein the first brightness enhancement film is disposed in a transmission path of the light beam.

11. The backlight module according to claim 10, wherein the prisms of the prism layer extend along a first direction and are arranged along a second direction.

12. The backlight module according to claim 11, wherein the first direction is substantially perpendicular to the second direction.

13. The backlight module according to claim 10, wherein the prisms are adjacent to each other.

14. The backlight module according to claim 10, further comprising a substrate, wherein the prism layer is disposed on the substrate.

15. The backlight module according to claim 14, wherein the ratio of an orthogonal projection area of the micro lens unit on the substrate to an orthogonal projection area of the corresponding prism unit on the substrate falls in a range between 25% and 60%.

16. The backlight module according to claim 10, wherein a cross section of the prism unit is a trapezoid.

17. The backlight module according to claim 10, wherein the micro lens units are rounded protrusions, elliptical protrusions, spherically-shaped protrusions, hemispherically-shaped protrusions, or the combination of the above mentioned protrusions.

18. The backlight module according to claim 10, wherein a curvature of the side surface of the connection structure unit is gradually increased along a direction away from the prism unit.

19. The backlight module according to claim 10, further comprising a second brightness enhancement film, wherein the second brightness enhancement film is substantially the same with the first brightness enhancement film, and the second brightness enhancement film and the first brightness enhancement film are disposed one above another and are substantially perpendicular to each other.
